(19) United States
(12) Patent Application Publication
(10) Pub. No.: US 2018/0288717 A1
(43) Pub. Date: Oct. 4, 2018

(54) PHASE SHIFT KEYING (PSK) WIRELESS COMMUNICATION FOR MEDICAL IMPLANTS

(71) Applicant: QUALCOMM Incorporated, San Diego, CA (US)

(72) Inventor: Stephen Jay Shellhammer, Ramona, CA (US)

(21) Appl. No.: 15/691,679

(22) Filed: Aug. 30, 2017

Related U.S. Application Data
(60) Provisional application No. 62/478,441, filed on Mar. 29, 2017.

(51) Int. Cl. H04W 56/00; H04L 27/22

(52) U.S. Cl. CPC H04W 56/005; H04W 84/18; H04L 27/22

(57) ABSTRACT

A communication packet (PHY packet) can include a plurality of subfields with a common symbol sequence that can be used for autocorrelation. The symbol sequence of each subfield may be multiplied by a constant of either +1 or −1, based on a different bit of a maximal length sequence, which can enable cross-correlation. Thus, this packet design enables packet detection, symbol timing recovery, and carrier frequency offset estimation.

### RELATED APPLICATIONS

This application claims the benefit of U.S. Provisional Application No. 62/478,441, filed Mar. 29, 2017, entitled “MICS BAND PHASE SHIFT KEYING (PSK) WIRELESS COMMUNICATION”, of which is assigned to the assignee hereof, and incorporated herein in its entirety by reference.

### BACKGROUND

A medical implant communication system (MICS) is a communication system used to provide wireless communication between electronic medical implants implanted within a person's body and an interrogator device located just outside the person's body. To preserve power the medical implants, they may use low-accuracy local oscillators, which means the wireless communication may need to tolerate relatively large inaccuracies in the carrier frequency generated using these local oscillators. These inaccuracies can be a challenge to deal with, especially in a system where the wireless communication uses phase shift keying (PSK).

### SUMMARY

Techniques described herein address these and other issues using a communication packet (PHY packet) design with a plurality of subfields with a common symbol sequence that can be used for autocorrelation. The symbol sequence of each subfield may be multiplied by a constant of either +1 or −1, based on a different bit of a maximal length sequence, which can enable cross-correlation. Thus, this packet design enables packet detection, symbol timing recovery, and carrier frequency offset estimation.

An example method of improved phase shift keying (PSK)-based wireless communication in low-power wireless systems, according to the description, comprises receiving, at a receiving device, a communication packet comprising a synchronization field, where the synchronization field comprises a plurality of subfields, each subfield of the plurality of subfields comprises a particular sequence of symbols where the particular sequence of symbols is common among all subfields of the plurality of subfields, and each subfield is multiplied by a constant of either +1 or −1, based on a different bit of a maximal length sequence. The method further comprises synchronizing the receiving device to the communication packet by performing an autocorrelation, with the receiving device, of at least two subfields of the plurality of subfields.

The method may comprise one or more of the following features. Synchronizing the receiving device further may comprise, after autocorrelating the at least two subfields, cross-correlating the maximal length sequence with a pre-stored sequence. The method may further comprise conducting multi-hypothesis testing based on the cross-correlating. The method may further comprise, after synchronizing the receiving device, decoding data in a data field of the communication packet with the receiving device. Synchronizing the receiving device may comprise, determining a frequency offset of the receiving device with respect to the communication packet, based on the autocorrelation. The communication packet may be received from a medical implant.

Another example method of improved phase shift keying (PSK)-based wireless communication in for low-power wireless systems, according to the description, may comprise creating, at a transmitting device, a communication packet comprising a synchronization field with a plurality of subfields, where the creating comprises including, in each subfield of the plurality of subfields, a particular sequence of symbols where the particular sequence of symbols is common among all subfields of the plurality of subfields, and multiplying each subfield by a constant of either +1 or −1, based on a different bit of a maximal length sequence. The method may further comprise wirelessly transmitting the communication packet from the transmitting device.

The method may comprise one or more of the following features. The transmitting device may comprise a medical implant. The method may further comprise including, in the communication packet, data collected by the medical implant.

An example receiving device for improved phase shift keying (PSK)-based wireless communication in a low-power wireless system, according to the description, comprises an antenna configured to receive a wireless signal encoded with a communication packet, and circuitry communicatively coupled with the antenna. The circuitry is configured to receive, from the antenna, the communication packet comprising a synchronization field having a plurality of subfields, where each subfield of the plurality of subfields comprises a particular sequence of symbols where the particular sequence of symbols is common among all subfields of the plurality of subfields, and each subfield is multiplied by a constant of either +1 or −1, based on a different bit of a maximal length sequence. The circuitry is further configured to synchronize the receiving device to the communication packet by performing an autocorrelation of at least two subfields of the plurality of subfields.

The example receiving device may further comprise one or more the following features. The circuitry may be further configured to synchronize the receiving device by, after autocorrelating the at least two subfields, cross-correlating the maximal length sequence with a pre-stored sequence. The circuitry may be further configured to conduct multi-hypothesis testing based on the cross-correlating. The circuitry may be further configured to, after synchronizing the receiving device, decode data in a data field of the communication packet with the receiving device. The circuitry may be configured to synchronize the receiving device by determining a frequency offset of the receiving device with respect to the communication packet, based on the autocorrelation. The antenna may be configured to receive the wireless signal from a medical implant. The circuitry may comprise a processing unit.

An example transmitting device for improved phase shift keying (PSK)-based wireless communication in for low-power wireless systems, according to the description, comprises circuitry configured to create a communication packet comprising a synchronization field with a plurality of subfields, where the circuitry is configured to include, in each subfield of the plurality of subfields, a particular sequence of symbols, where the particular sequence of symbols is common among all subfields of the plurality of subfields, and multiply each subfield by a constant of either +1 or −1, based on a different bit of a maximal length sequence. The transmitting device further includes an antenna communicatively coupled with the circuitry and configured to wirelessly transmit the communication packet from the transmitting device.

The transmitting device may further comprise one or more the following features. The transmitting device may comprise a medical implant. The transmitting device may further comprise one or more sensors, wherein the circuitry is further configured to include, in the communication packet, data collected by the one or more sensors. The circuitry may comprise a processing unit.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a simplified cross-sectional diagram illustrating a configuration of a wireless medical implant system in which a MICS may be used, according to an embodiment.

FIG. 2 is a diagram of an embodiment of a PHY layer packet.

FIG. 3 is a diagram of an embodiment of a Sync field 210.

FIG. 4 is an example preamble with y₁ and y₂ subfields (corresponding to sequential subfields illustrated in FIG. 3) for autocorrelation, according to an embodiment.

FIG. 5 is a block diagram showing a packet detection architecture capable of executing autocorrelation, according to an embodiment.

FIG. 6 is a graph of simulated autocorrelation results, according to an embodiment.

FIG. 7 is a block diagram illustrating how this autocorrelation may be implemented, according to an embodiment

FIGS. 8-10 are diagrams of simulation results showing phase rotation corrected cross-correlation, according to some embodiments.

FIG. 11 is a flow diagram of an example method of improved PSK-based wireless communication in low-power wireless systems, which may be implemented by a receiving device, according to an embodiment.

FIG. 12 is a flow diagram of an example method of improved PSK-based wireless communication in low-power wireless systems, which may be implemented by a transmitting device, according to an embodiment.

FIG. 13 is a simplified block diagram of an interrogator device, according to an embodiment

FIG. 14 is a simplified block diagram of a medical implant, according to an embodiment.

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

It will be understood by a person of ordinary skill in the art that, although the embodiments provided herein are directed toward medical applications and, in particular, medical implants, the techniques described herein may be utilized in other applications involving digital communication.

A medical implant communication system (MICS) is a communication system used by electronic medical implants and related devices, for example between a medical implant located inside a person's body (used to provide stimulation to the nervous system, for example) and an interrogator device located just outside the person's body. A MICS typically uses low-power, short-range radio frequency (RF) communication at a designated frequency band (e.g., 401-406 MHz). Many MICS-band wireless systems use a frequency shift keying (FSK) modulation scheme, but it is also possible to design a system that uses phase shift keying (PSK).

Electronic medical implants are often battery-operated implants (or even passive implants that collect energy from an interrogator device), and thereby typically need to operate on very low power consumption. But this can provide severe power constrains on the design of the local oscillator (LO) used for RF communication, because the accuracy of the LO is directly related to power consumption: low-power LOs (like a ring oscillator, which has few components) are less accurate than higher-power LOs. Thus, to preserve power in a medical implant system, wireless communication may need to tolerate relatively large inaccuracies in the carrier frequency.

Because an interrogator device is typically given a larger power budget then the medical implant, it may have a more accurate LO then the medical implant. As an example, the LO frequency accuracy in the interrogator device may be around 10 ppm (parts per million), while in the medical implant the LO frequency accuracy may be more like 50 ppm, or possibly higher. This results in a total frequency offset in communications between the interrogator device and the medical implant (difference in frequency between both ends of the link) may reach up to 60 ppm, or possibly higher.

In PSK implementations, the relatively large frequency offset between transmitter and receiver (e.g., medical implant and interrogator device) can be exacerbated by the fact that the baud rate is relatively low compared to the carrier frequency, resulting in significant phase rotation during a single PSK symbol. For example, for a 400 MHz carrier frequency, the frequency offset between transmitter and receiver is given by:

fₒ=400×10⁶(±δ10⁻⁶)=(±δ)400, (1)

where δ is the total frequency offset in parts per million (ppm).

For a baud rate of 150 kHz, the worst-case phase rotation during a single symbol is given by:

$$θ = \pm 2 π \frac{{f}_{o}}{{f}_{b}} = \pm ( 2 π ) \frac{400 δ}{150 \times {10}^{3}} = \pm \frac{( 2 π ) δ}{375} \qquad ( 2 )$$

This can result in large phase rotations over the course of just a few symbols. For example, for where δ is 40 ppm and 60 ppm the resulting phase rotations are ±0.2134 Tr and of ±0.32π respectively. This means a phase rotation of π can occur in just 3-5 symbols (roughly), in this example. Where so few symbols can be detected accurately, it can be difficult or impossible to perform cross-correlation (correlating the received signal with a pre-stored version of the synchronization signal) for packet detection.

Techniques disclosed herein address these and other issues by using a PHY packet design that enables packet detection, symbol timing recovery, and carrier frequency offset estimation by facilitating a process of autocorrelation and cross-correlation as described herein below.

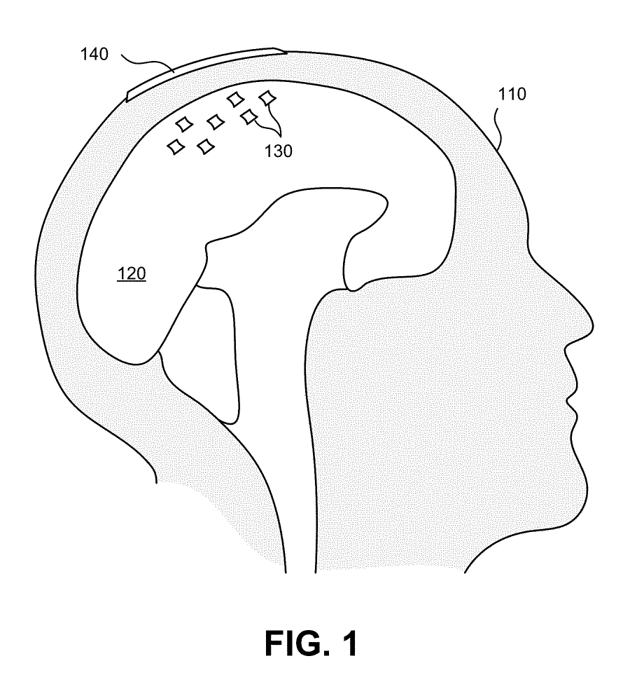

FIG. 1 is a simplified cross-sectional diagram illustrating a configuration of a wireless medical implant system in which a MICS may be used, according to an embodiment. Here, a patient's head 110 is illustrated, indicating a portion of the brain 120 in which a plurality of medical implants 130 are implanted. (For clarity, only a portion of the medical implants are labeled.) An interrogator device 140 can comprise one or more devices in communication with the medical implants 130, acting as a central controller for the medical implants 130 and using relatively low-power, short-range RF signals at a designated frequency communicate with and (in some embodiments) to provide power to the medical implants 130. Such wireless communication can employ any of a variety of short-range wireless technologies, including near-field communication (NFC) and/or other wireless technologies. According to some embodiments, data may be communicated in a secure fashion (e.g., using any of a variety of encryption techniques).

For this and similar configurations, the interrogator device 140 may be referred to as a “skin patch” because it may be substantially flat in shape and may be disposed on or near the patient's skin. The medical implants 130 in such scenarios may be referred to as “neurograins” because of their relatively small size and location within the patient's brain. That said, although the interrogator device 140 can be located on top or elsewhere attached to the outside the patient's head 110, alternative embodiments many include one or more devices located elsewhere, including in, on and/or in proximity to the patient's body.

Depending on the application, the biological measurement and stimulation system may comprise hundreds or thousands of medical implants 130. (Alternative embodiments may include a smaller or larger number of medical implants 130 than this.) These medical implants 130 can also communicate back to the interrogator device 140 (e.g., through RF backscatter, by changing the impedance of their respective antennas) using a time division multiple access (TDMA) protocol. The interrogator device 140 may coordinate the uplink transmission.

Medical implants 130 can comprise active devices (having a power source) and/or passive devices (having no power source) configured to take biological measurements of the brain 120 (e.g., information regarding electrical signals generated by the patient's brain cells) and communicate the measurements to the interrogator device 140 and/or provide stimulation of the patient's brain 120 (e.g., via one or more electrodes), where such stimulation may be based on communication received from the interrogator device 140. As previously noted, medical implants 130 can be powered by the interrogator device 140 using, for example, a coiled antenna drawing power from communications and/or other signals or fields generated by the interrogator device 140. It can be noted that, in alternative embodiments, the interrogator device 140 may comprise multiple antennas, and/or the biological measurement and stimulation system may have one or more nodes and/or devices between the medical implants 130 and the interrogator device 140. Because medical implants 130 can vary in functionality, they can vary in size, shape, type, and/or may have electrodes (and or other sensors) that vary as well.

Medical implants 130 may draw power from the interrogator device 140 (e.g., via a coiled antenna drawing power from communications and/or other signals or fields generated by the interrogator device 140), and may be passive (e.g., with no independent power source) or active. Active medical implants 130 may also draw power wirelessly from the interrogator device 140, which may be used to charge a battery or other power source(s). As noted below, an interrogator device 140 may comprise multiple antennas and/or the brain biological measurement and stimulation system may have one or more nodes (e.g., modules or devices) between the interrogator device 140 and the medical implants 130.

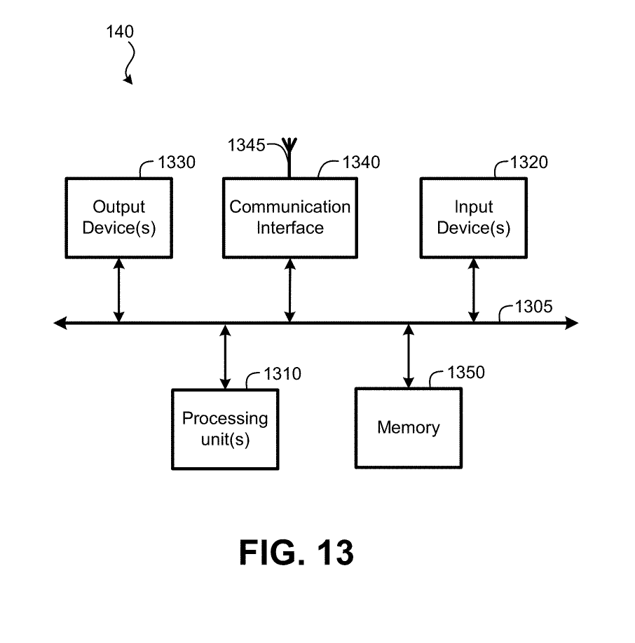

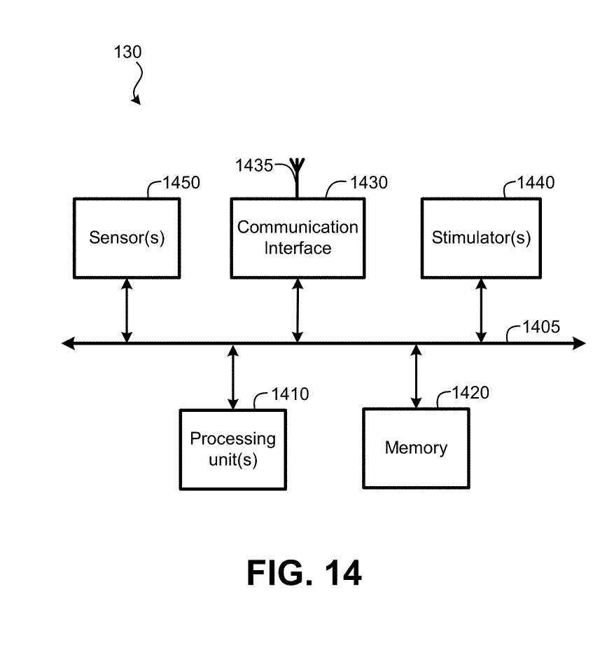

A person of ordinary skill in the art will appreciate the basic hardware configuration of an interrogator device 140 and/or medical implant 130. This can include, for example, a power source, processing unit, communication bus, volatile and/or non-volatile memory (which may comprise a non-transitory computer-readable medium having computer code for execution by the processing unit), transceiver, antenna, etc. The medical implant 130 may further comprise one or more sensors, electrodes, and/or stimulators utilized for sensing and/or stimulating one or more parts of the body. As such, the interrogator device 140 and/or medical implant 130 may have means for performing some, or all, of the functions described herein using one or more of its hardware and/or software components. In some embodiments, components may be selected and/or optimized for low power consumption. In particular, because medical implants 130 may be limited in size and/or power, the medical implants 130 may not have the same memory size and/or processing capabilities as the interrogator device 140. Example electrical hardware and software components of an interrogator device 140 and medical implant 130 are illustrated in FIG. 13 and FIG. 14, respectively, and described in more detail below.

As previously mentioned, power constrains on the design of the medical implants 130 may result in the medical implants having relatively inaccurate LOs. The wireless communication between the interrogator device 140 and medical implants 130 therefore may need to tolerate a relatively large frequency offset between the interrogator device and the medical implant. As described in detail below, embodiments can enable through the use of an improved PHY packet design that facilitates a process of autocorrelation and cross-correlation.

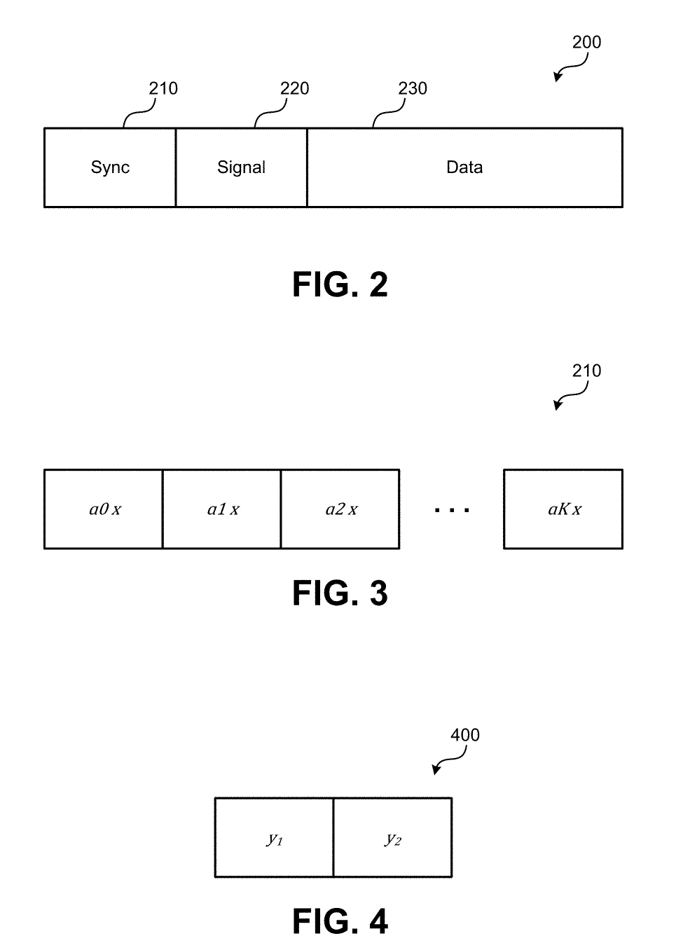

FIG. 2 is a diagram of such a PHY layer packet 200, according to an embodiment. As illustrated, the PHY layer packet 200 comprises three fields: a Sync field 210, a Signal field 220, and a Data field 230. Generally speaking, the Sync field 210 is used for packet detection, symbol timing recovery, and carrier frequency offset estimation. The Signal field 220 comprises a modulation and coding set (MCS) and length of the Data field 230 (which can vary), and the Data field 230 can carry the payload from the MAC layer.

### The Sync Field

The Sync field 210 is designed so the receiver can detect the packet, determine when it occurred, and further estimate the difference in the carrier frequency between the transmitter and the receiver. Because there may be relatively high carrier offsets (e.g., 60 ppm), and PSK is used, it may not be not practical to try to cross-correlate the received signal with a pre-stored version of that signal at the receiver. The reason for that is, as explained above, the phase of the signal at the receiver can rotate from symbol to symbol quite significantly due to this high frequency offset. Thus, over multiple symbols it is possible to get 180° or even 360° rotation. This phenomenon can totally destroy the output of any cross-correlator because the phases of the received signal may be quite different than the phases of the pre-stored signal at the receiver. With this in mind, techniques described in here utilize a specialized Sync field 210 as described in further detail below.

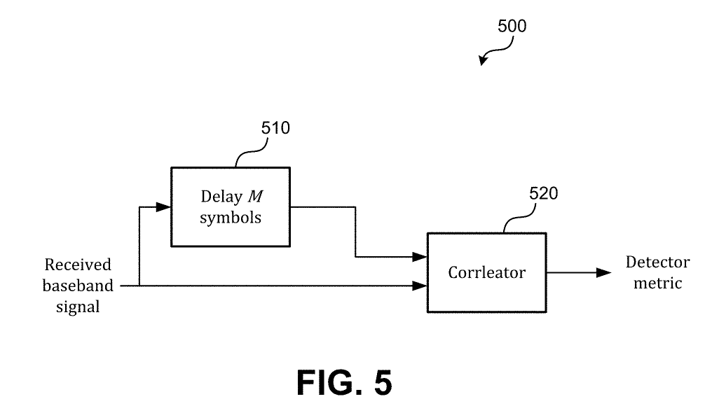

FIG. 3 is a diagram of an example Sync field 210, according to an embodiment. Here, the Sync field 210 comprises a sequence of subfields labeled “a0 x” to “aK x.” The x indicates a sequence of phase shift keying symbols of length M. The choice of the PSK symbols used in x can be either a sequence of Binary Phase Shift Keying (BPSK) symbols, Quadrature Phase Shift Keying (QPSK) symbols, or any other sequence of phase shift keying symbols. (The a variables represent constants in a bit sequence that do not affect the number of symbols in x, and can therefore be ignored for now. More details regarding these constants are provided below.) The key is that the PSK symbols are the same in each instance of the subfield x.

As noted above, cross-correlation cannot be used for packet detection due to the relatively high frequency offset between the transmitter and receiver. However, because the PSK symbols are the same for each instance of the subfield x, packet detection can be conducted by auto-correlating the received signal with itself (constructing the Sync field 210 as a concatenation of two sequences). Because x is normalized and is length M, it has the property:

x^{H}x=M. (1)

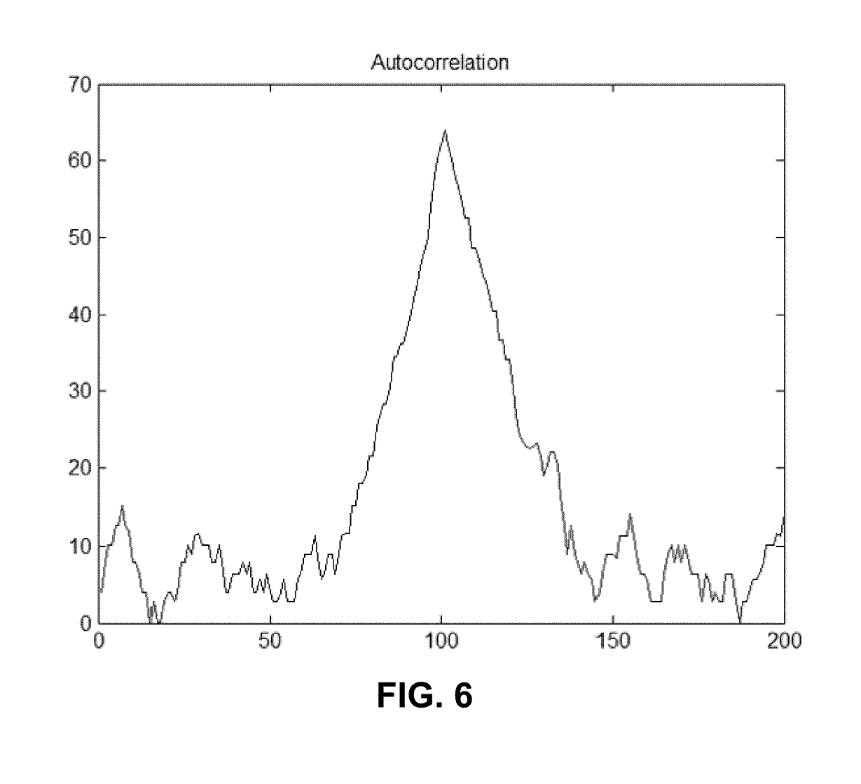

(Here, H (a Hermitian matrix) may be used where values are complex.)

Where θ is the phase rotation per symbol, then for a preamble 400 with y₁ and y₂ subfields (as shown in FIG. 4), the receive vector of the first part of the preamble can be represented by a vector:

$$\begin{matrix}{y}_{1} = Gx \\ where & ( 2 ) \\ G = ( \begin{matrix}{e}^{- j φ} & 0 & 0 \\ 0 & … & 0 \\ 0 & 0 & {e}^{- j ( ( M - 1 ) θ + φ )}\end{matrix} ) \\ and & ( 3 ) \\ {G}^{H} G = MI . & ( 4 )\end{matrix}$$

(Here I is the identity matrix.)

Delaying M symbols, the next received vector of the preamble 400 can be represented by:

y₂=e^{-jMθ}Gx, (5)

The inner (dot) product of vectors (2) and (5) is then:

y₂^{H}y₁=e^{jMθ}x^{H}G^{H}Gx=e^{jMθ}M². (6)

Hence the delays per symbol cancel out, and there is a strong correlation with phase rotation. Taking the absolute value of the inner product gives a strong packet detection metric. Also, the phase rotation per symbol can be obtained from the phase as long as:

|Mθ|<π. (7)

Thus, the number of symbols, M, in the phase shift keying sequence x may be selected based on a maximum expected value of θ (phase rotation per symbol). In other words, the value of M is selected so that the rotation from one subfield to the next is less than π radians (180°).

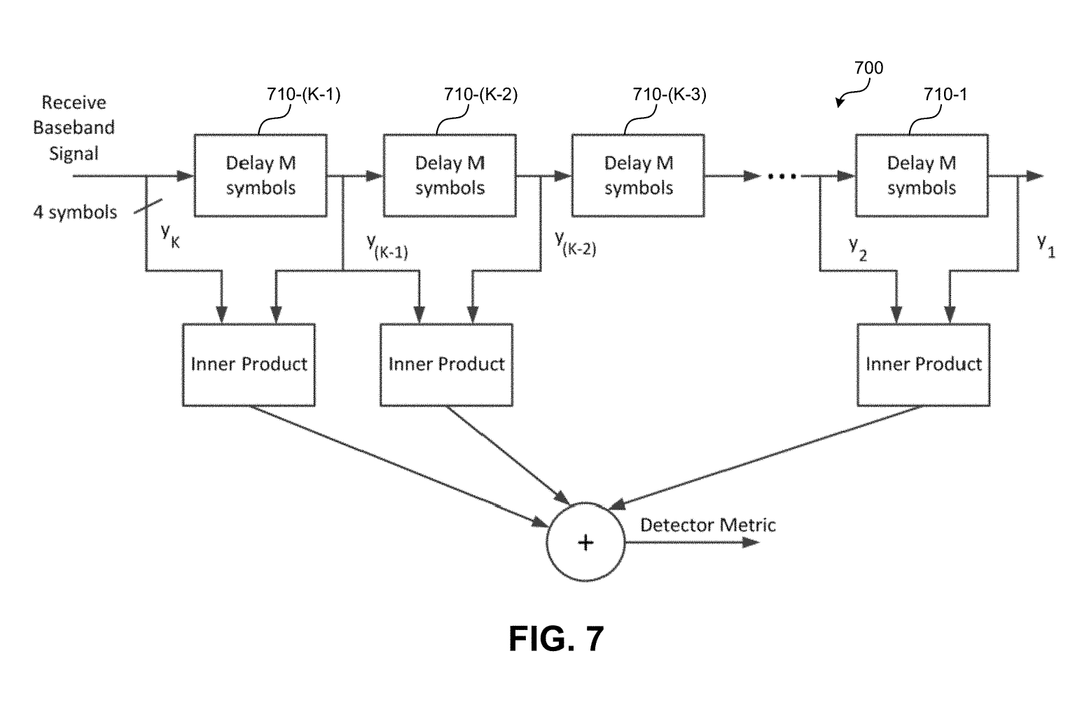

FIG. 5 is a block diagram showing a packet detection architecture 500 capable of executing the autocorrelation described above, according to an embodiment. Here, a received baseband signal is provided to both a symbol delay 510 and a correlator 520. The symbol delay 510 delays the received signal by M symbols, and the correlator 520 correlates the output of the symbol delay 510 (the delayed received baseband signal) with the received baseband signal, thereby performing an autocorrelation of the received signal with a time-delayed version of itself.

For high frequency offset, the length of the subfield may only be M=3 or 4. Longer values of M provide a stronger detection statistic, so it may be desirable to pick the largest value possible, depending on the maximum carrier frequency offset (ensuring condition (7) above is met).

Referring again to FIG. 3, because the Sync field 210 comprises K total subfields, it therefore allows (K−1) autocorrelations, each with a delay of M symbols. (It will be understood that a minimum value of K can be chosen to help achieve a desired signal to noise ratio (SNR) for a particular embodiment. The higher the value of K, the greater the SNR value.) Values M and K can be combined to get a stronger detection statistic under low signal to noise ratio (SNR). (Generally speaking, and as will be understood by a person of ordinary skill in the art, the smaller the value of M, the greater the value of K will need to be to help ensure correct autocorrelation.)

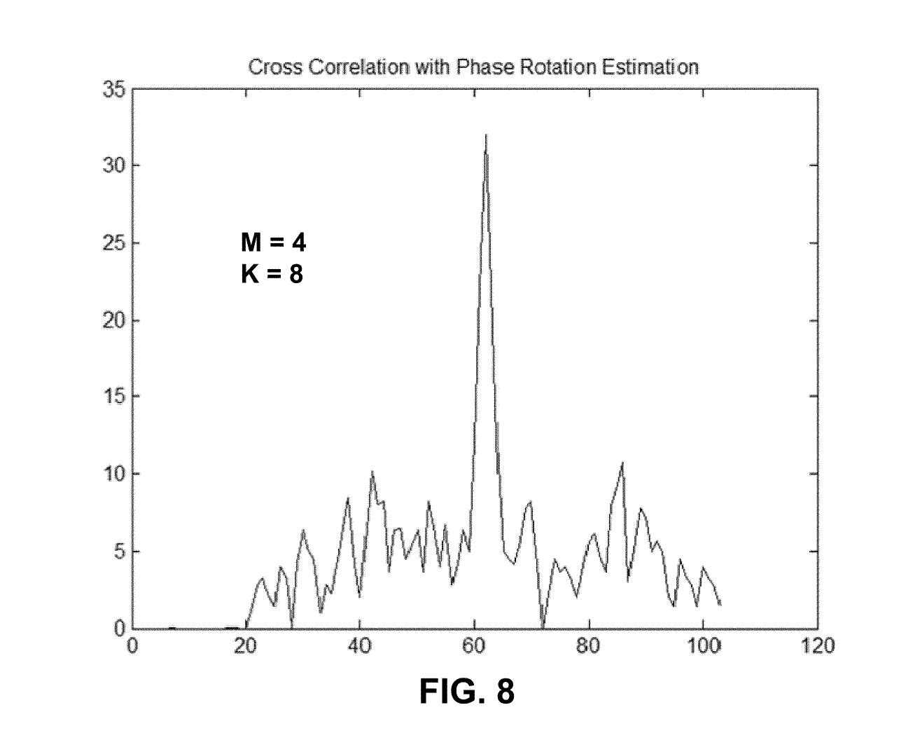

FIG. 6 is a graph of simulated autocorrelation results for K=32. Here, the results were identical for a carrier offset, δ, of 0 and 40 ppm. The height of the peak provides strong packet detection. However, the breadth of the peak does not provide for easy time synchronization. (The output with a one symbol offset may be almost as strong as for no symbol offset.)

With this in mind, embodiments may provide timing synchronization by further using cross-correlation. This can be enabled by the constants a0-aK in the Sync field 210 (see FIG. 3). In other words, according to embodiments, the Sync field may be designed to detect a packet (using autocorrelation), estimate the frequency offset, then using that frequency offset, use a cross-correlator to obtain timing synchronization.

Referring again to the subfields of the Sync field 210 illustrated in FIG. 3, each the symbol making up the subfield x is a PSK symbol. The constants a0 through aK are either 1 or −1. These constants multiply the symbols in the subfield x. So, for a ith subfield where ai is 1, then the ai x=x (so the subfield is just x). For a jth subfield where aj is −1 then aj x=−x, which indicates that each PSK symbol in x is rotated π radians (180°). The choice of the values of a is that they are based on maximal length pseudo random (PN) sequences, where a bit value of 1 indicates that a=1 and a bit value of 0 indicates that a=−1. The sequence {a0, a1, . . . aK} can be thought of as an overaly sequence multiplying each of the subfields.

Again, each subfield is short enough so that the total phase rotation during that field is less than π, so that we can then estimate the phase rotation. As noted above:

|Mθ|<π. (7)

By substituting (2) above (for a 150 kHz baud rate), we can solve for M:

$$\begin{matrix}\frac{M ( 2 π ) δ}{375} < π , & ( 8 ) \\ M < \frac{375}{2 δ} & ( 9 )\end{matrix}$$

For a maximum expected frequency offset of δ=40 ppm, for example, then M must be less than 4.6875. So, the maximum number of bits for M in this case would be 4. Of course, the value of M in alternative embodiments may vary with different expected frequency offset and/or baud rate.

Put differently, the bounds on the total frequency offset can be determined for each value of M. For instance, continuing with the example of a 150 kHz baud rate, a maximum total frequency offset can be calculated for various values of M. Taking equation (8) above and adding a 10% margin of error results in:

$$\frac{M ( 2 π ) δ}{375} < 0.9 π , \qquad ( 10 )$$

and consequentially,

$$δ < \frac{168.75}{M} . \qquad ( 11 )$$

Several values of M can then be tabulated as shown in the following Table:

TABLE 1

| M | Maximum Total Frequency Offset (δ) (ppm) |
|---|---|
| 1 | 169 |
| 2 | 84 |
| 3 | 56 |
| 4 | 42 |

It can be further noted that, according to some embodiments, disambiguation algorithms may be implemented to allow for phase rotations of greater than π radians within a subfield of the Sync field, which may impact the calculations above. For example, multi-hypothesis testing can be used to disambiguate phase rotations greater than π radians. The utilization of such multi-hypothesis testing may be based on available processing resources and/or other factors.

Thus, the Sync field comprises K subfields of length M, where each subfield is multiplied by a constant of a PN (or similar) sequence. Each subfield is given by:

yₖ=aₖx. (12)

Packet detection can be done using multiple short autocorrelations:

aₖ₊₁*aₖyₖ₊₁^{H}yₖ=e^{jMθ}M². (13)

K−1 autocorrelators can then be used:

Σₖ₌₁^{K-1}aₖ₊₁*aₖyₖ₊₁^{H}yₖ=(K−1)e^{jMθ}M², (14)

where the magnitude can be used for packet detection and the phase for frequency offset estimation. Here, known values of the overlay sequence can be used at the receiver when doing the sum of cross-correlations, and e^{jMθ} may be used to solve for θ. As shown in equation (14) above, the output of the sum of these (K−1) short cross-correlations not only can be used for packet detection but also to estimate the frequency offset. The phase offset can then be used to correct the phase and perform cross-correlation for timing synchronization.

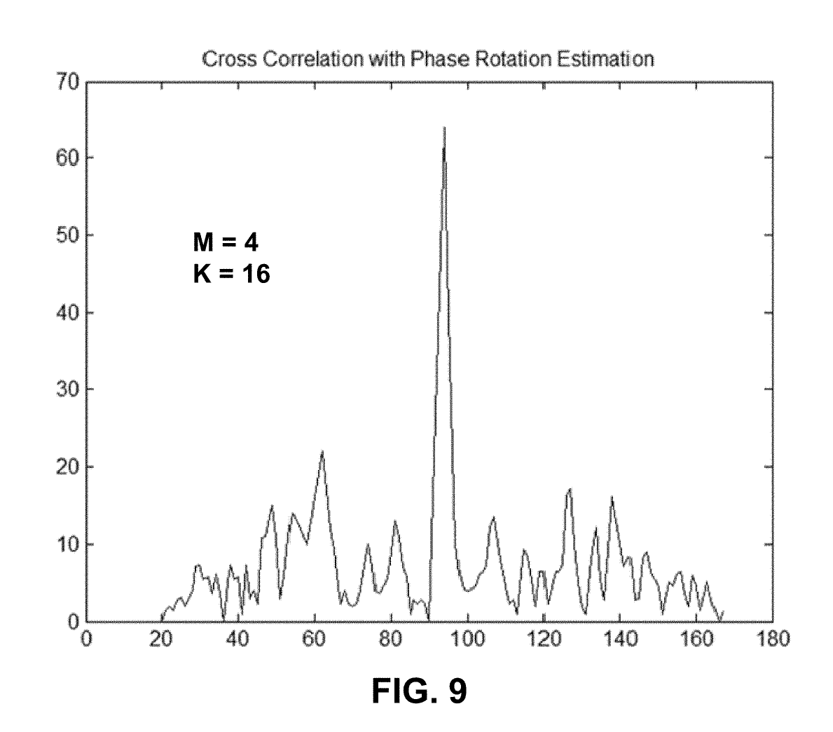

FIG. 7 is a block diagram 700 illustrating how this autocorrelation may be implemented, according to an embodiment. This can be implemented, for example, by one or more hardware and/or software components of a medical device or interrogator device as illustrated in FIGS. 13 and 14 described below. As illustrated, the autocorrelation can be made using K−1 symbol delay modules (710-(K−1), 710-(K−2), 710-(K−3), and 710-1, generically and collectively referred to as symbol delay modules 710), the first symbol delay module 710-(K−1) delaying the incoming baseband signal M symbols, and each successive symbol delay module delaying the signal an additional M symbols. The inner product of the input and time-delayed output of each symbol delay module 710 is taken to provide an autocorrelated output, and the outputs of all inner products are used to provide the detector metric.

With regard to the frequency offset, once frequency offset is known it can be compensated for by multiplying the received samples by a rotating exponential of the negative of that frequency offset. If that frequency offset estimate is good, then the corrected received signal has very little frequency offset from a pre-stored version of the Sync Field at the receiver. Accordingly, a cross-correlation can be performed between the corrected received signal and the pre-stored version of the Sync Field. Because the sequence ak is a maximal length sequence the cross-correlation provides an excellent test statistic, a very strong magnitude will be achieved when the signals are time aligned and a very weak magnitude when they are not.

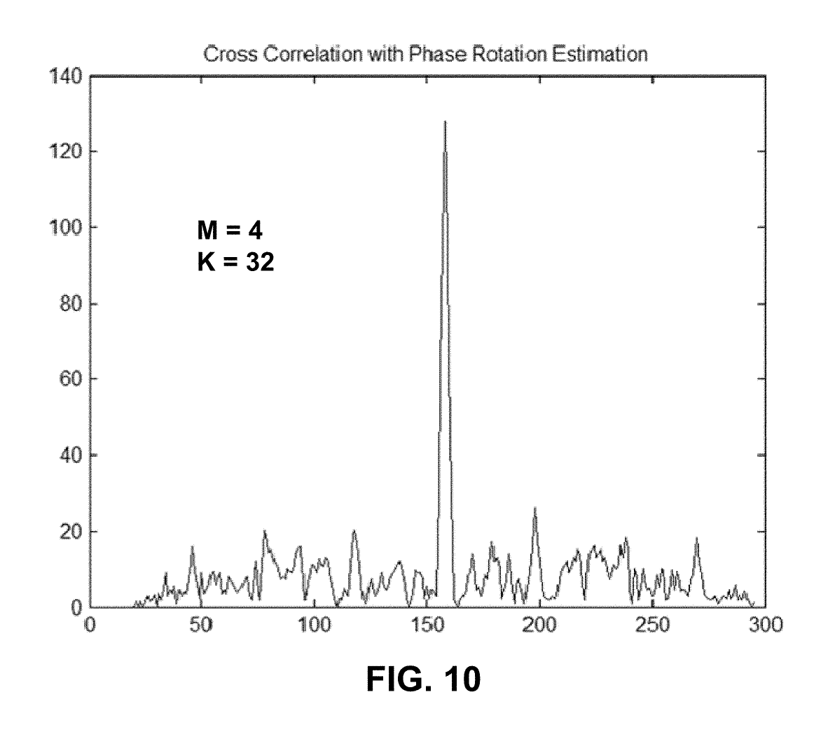

FIGS. 8-10 are diagrams of simulation results showing phase rotation corrected cross-correlation performed in this manner. FIG. 8 is a simulation where M=4 and K=8, FIG. 9 is a simulation where M=4 and K=16. FIG. 10 is a simulation where M=4 and K=32. If the output of the cross correlator is strong enough then the packet is detected at that time and the frequency offset is given from the earlier calculation. A fixed threshold is used to determine if the output of the cross correlator is strong enough. The value of that fixed threshold is selected so that the probability of detecting on noise or on interference is negligible.

### The Signal Field

Referring again to FIG. 2, the field following the Sync field 210 in the PHY layer packet 200, according to techniques herein, is the Signal field 220. According to embodiments, the Signal field can carry two pieces of information: (1) the modulation and coding scheme (MCS), and (2) the length of the Data field in bytes.

In this design four different modulation and coding schemes may be supported, according to some embodiments, as shown in Table 2 below. In this example, the PSK symbol rate is 150 kHz in order for the waveform to meet the 300 kHz maximum bandwidth regulations for the MICS band. (Other embodiments, such as in systems not regulated by the MICS band, may have different symbol rates, depending on desired functionality.) The four MCS modes can be indicated using two bits.

TABLE 2

| MCS | Modulation | FEC Code Rate | Data Rate |
|---|---|---|---|
| 0 | D-BPSK | 1/2 | 75 kb/s |
| 1 | D-BPSK | 1 | 150 kb/s |
| 2 | D-QPSK | 1/2 | 150 kb/s |
| 3 | D-QPSK | 1 | 300 kb/s |

According to some embodiments, and depending on governing standards and/or protocols, the maximum length of the Data field may be 1024 Bytes. To convey this length, therefore, can require 10 bits of information within the Signal field. Combining the two bits for the MCS mode and the 10 bits for the length, a total of 12 bits of information may be needed for the Signal field.

According to some embodiments, a parity bit may be used, to bring the total to 13 bits. The parity bit may be used at the receiver to check the validity of the decoded Signal field. These 13 bits may then, according to some embodiments, the encoded with a “repetition by 3” forward error correction (FEC) code. This is a simple code produces 39 code bits (3×13). According to some embodiments (and depending on the governing standards and/or protocols), these 39 code bits can be modulated using differential BPSK (D-BPSK) to produce the Signal field 220. Differential coding may be used to avoid having to estimate the exact phase of the transmitted signal.

### The Data Field

Referring again to FIG. 2, the Data field 230 receives the payload from the MAC layer. In some embodiments, the Data field 230 may always be an integer number of bytes, with (according to some embodiments) a maximum length of 1024 bytes. If the MCS indicates a FEC code rate of 1/2, then these payload bits may be encoded with a rate 1/2 convolutional FEC code. If the MCS indicates an FEC code rate of 1 then no FEC may be applied. The bits may then be modulated onto D-BPSK or differential QPSK (D-QPSK) symbols, depending on the MCS value.

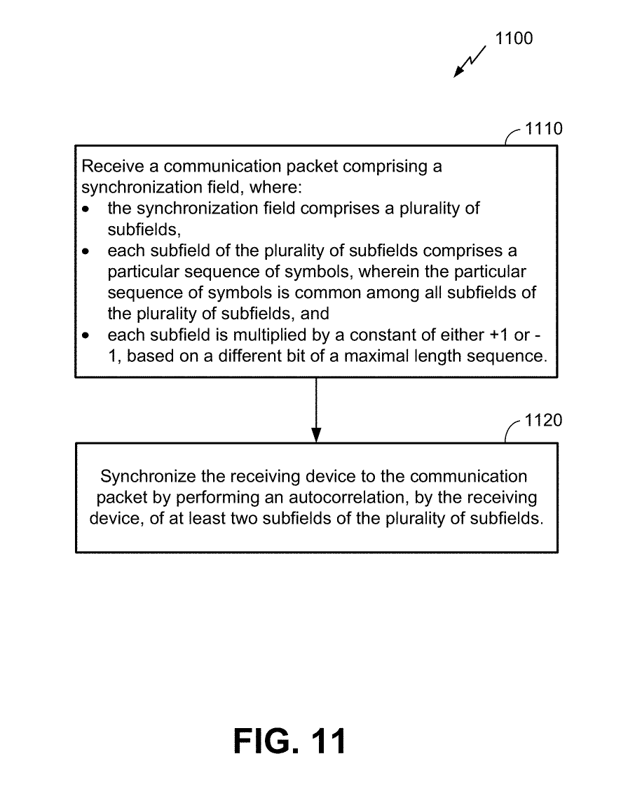

FIG. 11 is a flow diagram of an example method 1100 of improved PSK-based wireless communication in low-power wireless systems, according to an embodiment. The functionality described in one or both blocks illustrated in FIG. 11 may be performed, for example, by a receiving device in a low-power wireless system, such as an interrogator device 140 of the wireless medical implant system illustrated in FIG. 1. Accordingly, means for performing this functionality may include hardware and/or software components of an interrogator device 140. An example of such hardware and/or software components is illustrated in FIG. 13 and described in more detail below.

The functionality at block 1110 includes receiving a communication packet comprising a synchronization field. Here, the synchronization field comprises a plurality of subfields, each subfield of the plurality of subfields comprises a particular sequence of symbols (where the particular sequence of symbols is common among all subfields of the plurality of subfields), at each subfield is multiplied by a constant of either +1 or −1, based on a different bit of a maximal length sequence. As indicated in the embodiments above and illustrated in FIG. 3, each subfield may comprise a sequence of symbols (e.g., PSK symbols), x, which can be used for autocorrelation. Means for performing the functionality at block 1110 may comprise, for example, antenna(s) 1345, communication interface 1340, processing unit(s) 1310, memory 1350, bus 1305, and/or other components of an interrogator device 140, as illustrated in FIG. 13 and described in more detail below.

At block 1120, the functionality includes synchronizing the receiving device to the communication packet by performing an autocorrelation, by the receiving device, of at least two subfields of the plurality of subfields. As described in the embodiments above, for a communication packet with K subfields, this autocorrelation may be performed by K−1 autocorrelators (e.g., by delaying, at each autocorrelater, an input signal by the number of symbols in the sequence of signals and taking the inner product of the autocorrelater's input and output, as illustrated in FIG. 7). Means for performing the functionality at block 1120 may comprise, for example, processing unit(s) 1310, memory 1350, bus 1305, and/or other components of an interrogator device 140, as illustrated in FIG. 13 and described in more detail below.

As described above, the process may include additional functionality. In a wireless medical implant system, for example, the communication packet may be received from a medical implant. In some embodiments, synchronizing the receiving device may further comprise, after autocorrelating the at least two subfields, cross-correlating the maximal length sequence with a pre-stored sequence. Additionally or alternatively, multi-hypothesis testing based on the cross-correlation may be performed, which, as described above, can be used to increase the maximum total frequency offset allowable in the low-power wireless system. In some embodiments, the method 1100 may include decoding data in a data field of the communication packet with the receiving device after synchronizing the receiving device. As noted above, synchronizing the receiving device may comprise determining a frequency offset of the receiving device with respect to the communication packet, based on the autocorrelation.

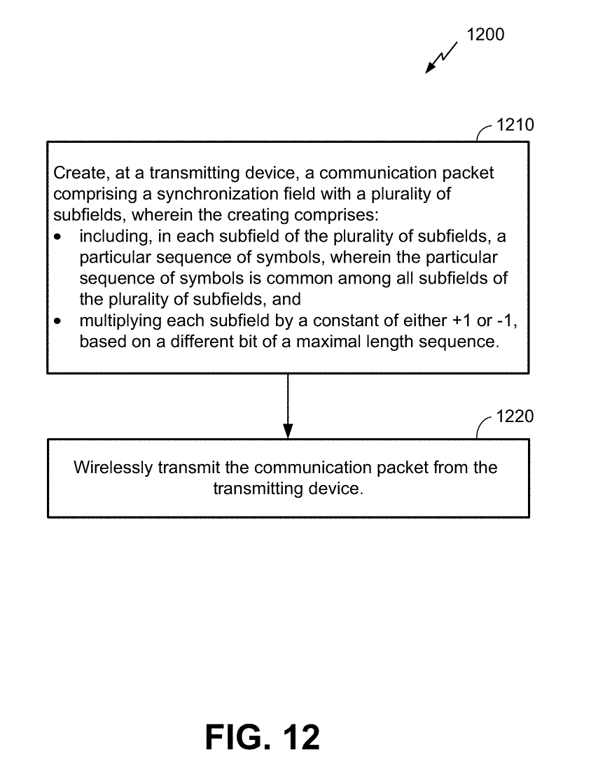

FIG. 12 is a flow diagram of an example method 1200 of improved PSK-based wireless communication in low-power wireless systems, according to another embodiment. Here, the functionality described in one or both blocks illustrated in FIG. 12 may be performed, for example, by a transmitting device in a low-power wireless system, such as a medical implant 130 of the wireless medical implant system illustrated in FIG. 1. Accordingly, means for performing this functionality may include hardware and/or software components of a medical implant 130. An example of such hardware and/or software components is illustrated in FIG. 14 and described in more detail below.

The functionality at block 1210 includes creating, at a transmitting device, a communication packet comprising a synchronization field with a plurality of subfields. The creating comprises including, in each subfield of the plurality of subfields, a particular sequence of symbols (where the particular sequence of symbols is common among all subfields of the plurality of subfields), and multiplying each subfield by a constant of either +1 or −1, based on a different bit of a maximal length sequence. Again, each subfield may comprise a sequence of symbols (e.g., PSK symbols), x, which can be used for autocorrelation by the receiving device in the manner described in the embodiments provided herein. Means for performing the functionality at block 1210 may comprise, for example, processing unit(s) 1410, memory 1420, bus 1405, and/or other components of a medical implant 130, as illustrated in FIG. 14 and described in more detail below.

At block 1220, the communication packet is wirelessly transmitted from the transmitting device. Means for performing this functionality may comprise, for example, antenna 1435, communication interface 1430, processing unit(s) 1410, memory 1420, bus 1405, and/or other components of a medical implant 130, as illustrated in FIG. 14 and described in more detail below.

FIG. 13 is a simplified block diagram of an interrogator device 140, according to an embodiment. The interrogator device 140 may comprise a “skin patch” (similar to the interrogator device of FIG. 1) or other device configured to perform one or more of the functions of an interrogator device as described in embodiments herein. FIG. 13 is meant only to provide a generalized illustration of various components, any or all of which may be included or omitted as appropriate. The interrogator device 140 may be configured to execute one or more functions of the methods described herein, such as the method 1100 illustrated in FIG. 11. It can be further noted that the interrogator device 140 may be configured to receive measurements from and/or stimulate a body part utilizing one or more medical implants with which the interrogator device 140 is in wireless communication, as described in the embodiments above. In some embodiments, the particular measurements taken and/or stimulations may be determined by the interrogator device 140 itself, and/or be determined by another device (such as a medical device, mobile phone, tablet, etc.) with which the interrogator device 140 is in communication. A person of ordinary skill in the art will understand that, for the sake of simplicity, some components (e.g., power source, clock, physical housing, etc.) are not shown.

The interrogator device 140 is shown comprising hardware elements that can be electrically coupled via a bus 1305 (or may otherwise be in communication, as appropriate). The hardware elements may include a processing unit(s) 1310 which may comprise without limitation one or more general-purpose processors, one or more special-purpose processors (such as digital signal processing (DSP) chips, graphics acceleration processors, application specific integrated circuits (ASICs), and/or the like), and/or other logic, processing structure, or means, which can be configured to perform one or more of the methods described herein.

Depending on desired functionality, the interrogator device 140 also may comprise one or more input devices 1320, which may comprise without limitation one or more, touch sensors, buttons, switches, and/or more sophisticated input components, which may provide for user input, which may enable the system to power on, configure operation settings, and/or the like. Output device(s) 1330 may comprise, without limitation, light emitting diode (LED)s, speakers, and/or more sophisticated output components, which may enable feedback to a user, such as an indication the implant system has been powered on, is in a particular state, is running low on power, and/or the like.

The interrogator device 140 might also include a communication interface 1340 and one or more antennas 1345. This communication interface 1340 and antenna(s) 1345 can enable the interrogator device 140 to communicate with and optionally power the medical implants of the wireless medical implant system. The one or more antennas 1345 can be configured to, when powered properly, generate particular signals and/or fields to communicate with and/or power the medical implants, including communicating medical implant selection methods as described herein. As previously indicated, medical implants in some embodiments may communicate using RF backscatter, in which case the interrogator device 140 may transmit an RF carrier signal, modulated by the medical implants during uplink communications.

In some embodiments, the processing unit(s) 1310 and/or communication interface 1340 (including software and/or firmware executed therewith) may implement the autocorrelation and/or cross-correlation described herein and illustrated in FIGS. 5 and 7.

The communication interface 1340 may further enable the interrogator device 140 to communicate with one or more devices outside the biological measurement and stimulation system to which the interrogator device 140 belongs, such as a medical device, mobile phone, tablet, etc. In some embodiments, the one or more devices may execute a software application that provides a user interface (e.g., a graphical user interface) for configuring and/or managing the operation of the interrogator device 140. The communication interface may include connectors and/or other components for wired communications (e.g., universal serial bus (USB) Ethernet, optical, and/or other communication). Additionally, or alternatively, the communication interface 1340 and optionally the antenna(s) 1345 may be configured to provide wireless communications (e.g., via Bluetooth®, Bluetooth® low energy (BLE), Institute of Electrical and Electronics Engineers (IEEE) 802.11, IEEE 802.15.4 (or ZIGBEE®), Wi-Fi, WiMAX™, cellular communications, infrared, etc.). As such, the communication interface 1340 may comprise without limitation a modem, a network card, an infrared communication device, a wireless communication device, and/or a chipset.

The interrogator device 140 may further include and/or be in communication with a memory 1350. The memory 1350 may comprise, without limitation, local and/or network accessible storage such as optical, magnetic, solid-state storage (e.g., random access memory (“RAM”) and/or a read-only memory (“ROM”)), or any other non-transitory, computer-readable medium. The memory 1350 may therefore make the interrogator device 140 can be programmable, flash-updateable, and/or the like. Such storage devices may be configured to implement any appropriate data stores, including without limitation, various file systems, database structures, and/or the like.

The memory 1350 of the interrogator device 140 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. For example, one or more procedures described with respect to the functionality discussed above might be implemented as computer code and/or instructions executable by the interrogator device 140 (and/or processing unit(s) 1310 of the interrogator device 140). The memory 1350 may therefore comprise non-transitory machine-readable media having the instructions and/or computer code embedded therein/thereon.

FIG. 14 is a simplified block diagram of a medical implant 130, according to an embodiment. The medical implant 130 may comprise a “neurograin” (similar to the medical implants 130 of FIG. 1) or other device configured to perform one or more of the functions of a medical implant of a biological measurement and stimulation system as described in embodiments herein. FIG. 14 is meant only to provide a generalized illustration of various components, any or all of which may be included or omitted as appropriate. It can be further noted that the medical implant 130 may be configured to take measurements and/or stimulate a body part as directed by an interrogator device 140 using communications such as those described in the embodiments herein. A person of ordinary skill in the art will understand that, for the sake of simplicity, some components (e.g., power source, clock, physical housing, etc.) are not shown. It will be understood that, in most embodiments, hardware and/or software optimizations may be made to help minimize power consumption.

The medical implant 130 is shown comprising hardware elements that can be electrically coupled via a bus 1405, or may otherwise be in communication, as appropriate. The hardware elements may include a processing unit(s) 1410 which may comprise without limitation one or more general-purpose processors, one or more special-purpose processors (e.g., microprocessors), and/or other logic, processing structure, or means, which can be configured to perform one or more of the methods described herein. The processing unit(s) 1310, may further include one or more counters (implemented in hardware and/or software) as described herein.

The medical implant 130 may further include and/or be in communication with a memory 1420. As with other components of the medical implant 130, the memory 1420 may be optimized for minimum power consumption. In some embodiments, the memory 1420 may be incorporated into the processing unit(s) 1410. Depending on desired functionality, the memory (which can include a non-transitory computer-readable medium, such as a magnetic, optical, or solid-state medium) may include computer code and/or instructions executable by the processing unit(s) 1410 to perform one or more functions described in the embodiments herein.

A communication interface 1430 and antenna(s) 1435 can enable the medical implant 130 to wirelessly communicate the interrogator device, as described herein. The antenna(s) 1435 may comprise a coiled or other antenna configured to draw power from communications and/or other signals or fields generated by the interrogator device, powering the medical implant 130. In some embodiments, the medical implant 130 may further include an energy storage medium (e.g., a battery, capacitor, etc.) to store energy captured by the antenna(s) 1435. In some embodiments, the communication interface 1430 and antenna(s) 1435 may be configured to the interrogator device using RF backscatter, as noted above.

The stimulator(s) 1440 of the medical implant 130 can enable the medical implant 130 to provide stimulation to a body part (e.g., biological tissue) in which the medical implant 130 is implanted. As such, the stimulator(s) 1440 may comprise an electrode, light emitting diode (LED), and/or other component configured to provide electrical, optical, and/or other stimulation. The processing unit(s) 1410 may control the operation of the stimulator(s) 1440, and may therefore control the timing, amplitude, and/or other stimulation provided by the stimulator(s) 1440.

The sensor(s) 1450 may comprise one or more sensors configured to receive input from a body part (e.g., biological tissue), in which the medical implant 130 is implanted. Sensors may therefore be configured to sense electrical impulses, pressure, temperature, light, conductivity/resistivity, and/or other aspects of a body part. As described herein, embodiments may enable medical implant 130 to provide this information, via the communication interface 1430, to an interrogator device (e.g., via a data field, such as the Data field 230 illustrated in FIG. 2). Depending on desired functionality, information received by the sensor(s) 1450 may be encrypted, compressed, and/or otherwise processed before it is transmitted via the communication interface 1430.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method of improved phase shift keying (PSK)-based wireless communication in low-power wireless systems, the method comprising:
receiving, at a receiving device, a communication packet comprising a synchronization field, wherein:
the synchronization field comprises a plurality of subfields,
each subfield of the plurality of subfields comprises a particular sequence of symbols, wherein the particular sequence of symbols is common among all subfields of the plurality of subfields, and
each subfield is multiplied by a constant of either +1 or −1, based on a different bit of a maximal length sequence; and
synchronizing the receiving device to the communication packet by performing an autocorrelation, with the receiving device, of at least two subfields of the plurality of subfields.

2. The method of claim 1, wherein synchronizing the receiving device further comprises, after autocorrelating the at least two subfields, cross-correlating the maximal length sequence with a pre-stored sequence.

3. The method of claim 2, further comprising multi-hypothesis testing based on the cross-correlating.

4. The method of claim 1, further comprising, after synchronizing the receiving device, decoding data in a data field of the communication packet with the receiving device.

5. The method of claim 1, wherein synchronizing the receiving device comprises, determining a frequency offset of the receiving device with respect to the communication packet, based on the autocorrelation.

6. The method of claim 1, wherein the communication packet is received from a medical implant.

7. A method of improved phase shift keying (PSK)-based wireless communication in for low-power wireless systems, the method comprising:
creating, at a transmitting device, a communication packet comprising a synchronization field with a plurality of subfields, wherein the creating comprises:
including, in each subfield of the plurality of subfields, a particular sequence of symbols, wherein the particular sequence of symbols is common among all subfields of the plurality of subfields, and
multiplying each subfield by a constant of either +1 or −1, based on a different bit of a maximal length sequence; and
wirelessly transmitting the communication packet from the transmitting device.

8. The method of claim 7, wherein the transmitting device comprises a medical implant.

9. The method of claim 8, further comprising including, in the communication packet, data collected by the medical implant.

10. A receiving device for improved phase shift keying (PSK)-based wireless communication in a low-power wireless system, the receiving device comprising:
an antenna configured to receive a wireless signal encoded with a communication packet; and
circuitry communicatively coupled with the antenna and configured to:
receive, from the antenna, the communication packet comprising a synchronization field having a plurality of subfields, wherein:
each subfield of the plurality of subfields comprises a particular sequence of symbols, wherein the particular sequence of symbols is common among all subfields of the plurality of subfields, and
each subfield is multiplied by a constant of either +1 or −1, based on a different bit of a maximal length sequence; and
synchronize the receiving device to the communication packet by performing an autocorrelation of at least two subfields of the plurality of subfields.

11. The receiving device of claim 10, wherein the circuitry is further configured to synchronize the receiving device by, after autocorrelating the at least two subfields, cross-correlating the maximal length sequence with a pre-stored sequence.

12. The receiving device of claim 11, wherein the circuitry is further configured to conduct multi-hypothesis testing based on the cross-correlating.

13. The receiving device of claim 10, wherein the circuitry is further configured to, after synchronizing the receiving device, decode data in a data field of the communication packet with the receiving device.

14. The receiving device of claim 10, wherein the circuitry is configured to synchronize the receiving device by determining a frequency offset of the receiving device with respect to the communication packet, based on the autocorrelation.

15. The receiving device of claim 10, wherein the antenna is configured to receive the wireless signal from a medical implant.

16. The receiving device of claim 10, wherein the circuitry comprises a processing unit.

17. A transmitting device for improved phase shift keying (PSK)-based wireless communication in for low-power wireless systems, the transmitting device comprising:
circuitry configured to create a communication packet comprising a synchronization field with a plurality of subfields, wherein the circuitry is configured to:
include, in each subfield of the plurality of subfields, a particular sequence of symbols, wherein the particular sequence of symbols is common among all subfields of the plurality of subfields, and
multiply each subfield by a constant of either +1 or −1, based on a different bit of a maximal length sequence; and
an antenna communicatively coupled with the circuitry and configured to wirelessly transmit the communication packet from the transmitting device.

18. The transmitting device of claim 17, wherein the transmitting device comprises a medical implant.

19. The transmitting device of claim 18, further comprising one or more sensors, wherein the circuitry is further configured to include, in the communication packet, data collected by the one or more sensors.

20. The transmitting device of claim 17, wherein the circuitry comprises a processing unit.
